(19) United States
(12) Patent Application Publication
(10) Pub. No.: US 2018/0039728 A1
(43) Pub. Date: Feb. 8, 2018

(54) OPERATING METHOD OF APPARATUS FOR ANALYZING GENOME SEQUENCES USING DISTRIBUTED PROCESSING

(71) Applicant: SAMSUNG ELECTRONICS CO., LTD., Suwon-si (KR)

(72) Inventor: JIN-KI KIM, Hwaseong-si (KR)

(21) Appl. No.: 15/467,310

(22) Filed: Mar. 23, 2017

(30) Foreign Application Priority Data
Aug. 8, 2016 (KR) 10-2016-0100882

(51) Int. Cl. G06F 19/22

(52) U.S. Cl. CPC G06F 19/22

(57) ABSTRACT

An operating method of an apparatus for analyzing a genome sequence includes mapping a plurality of sequenced read sequences to a reference genome. The method includes calculating a number of mapped read sequences. The reference genome is divided into a plurality of first regions based on the number of mapped read sequences. The mapped read sequences in each of the plurality of first regions are analyzed by performing distributed processing on the plurality of first regions.

### CROSS-REFERENCE TO RELATED APPLICATION

This application claims priority under 35 U.S.C. §119 to Korean Patent Application No. 10-2016-0100882, filed on Aug. 8, 2016, in the Korean Intellectual Property Office, the disclosure of which is incorporated by reference herein in its entirety.

### TECHNICAL FIELD

Exemplary embodiments of the present inventive concept relate to an operating method of an apparatus for analyzing a genome sequence, and more particularly to analyzing genome sequences using distributed processing.

### DISCUSSION OF RELATED ART

A genome includes all genetic information regarding a living thing. Genome sequencing technologies include a deoxyribonucleic acid (DNA) chip and Next Generation Sequencing (NGS) technology, Next Next Generation Sequencing (NNGS). Next generation sequencing may be interchangeably used with large-scale parallel sequencing or second-generation sequencing.

Genome data may include several tens to several hundreds of gigabytes of data. In analysis of genome data, a plurality of individual tools may be employed. Thus, a genome analysis pipeline may include software for integrating these individual tools, managing input/output and automatizing a step prior to genome data analysis.

### SUMMARY

An exemplary embodiment of the present inventive concept provides a method of analyzing read sequences at a relatively high speed based on information regarding the mapped read sequences.

According to an exemplary embodiment of the present inventive concept, an operating method of an apparatus for analyzing a genome sequence includes mapping a plurality of sequenced read sequences to a reference genome. The method includes calculating a number of mapped read sequences. The reference genome is divided into a plurality of first regions based on the number of mapped read sequences. The mapped read sequences in each of the plurality of first regions are analyzed by performing distributed processing on the plurality of first regions.

According to an exemplary embodiment of the present inventive concept, an operating method of an apparatus for analyzing a genome sequence includes receiving a plurality of read sequences of a genome. The plurality of received read sequences is mapped to a reference genome. The reference genome is divided into a plurality of regions. Frequency information regarding a depth of the mapped read sequences is extracted. A maximum depth is set based on the frequency information. The read sequences mapped to each of the regions are analyzed by performing distributed processing on the read sequences below the maximum depth.

### BRIEF DESCRIPTION OF THE DRAWINGS

The above and other features of the inventive concept will become more apparent by describing in detail exemplary embodiments thereof, with reference to the accompanying drawing, in which:

FIG. 1 is a flowchart illustrating an operating method of an apparatus for analyzing a genome sequence according to an exemplary embodiment of the present inventive concept;

FIG. 2 is a flowchart illustrating genome sequence analysis an exemplary embodiment of the present inventive concept; and

FIG. 3 is a flowchart illustrating region generation of FIG. 2 according to an exemplary embodiment of the present inventive concept;

FIG. 4 illustrates a reference genome divided into a plurality of first regions, an exemplary embodiment of the present inventive concept;

FIG. 5 is a flowchart illustrating a process of depth filtration an exemplary embodiment of the present inventive concept;

FIG. 6 illustrates a high depth interval (HD) divided from a reference genome according to an exemplary embodiment of the present inventive concept;

FIG. 7 is a flowchart illustrating genome sequence analysis according to an exemplary embodiment of the present inventive concept;

FIG. 8 is a distribution chart in a case where region generation and depth filtration according to an exemplary embodiment of the present inventive concept are not applied, and a distribution chart in a case where region generation and depth filtration according to an exemplary embodiment of the present inventive concept are applied;

FIG. 9 is a distribution chart illustrating a proceeding time according to regions of subsequent analysis operations in each of the cases of FIG. 8 according to an exemplary embodiment of the present inventive concept;

FIG. 10 is a view of a distributed processing system for analyzing a genome sequence according to an exemplary embodiment of the present inventive concept; and

FIG. 11 illustrates a system for analyzing a genome sequence to which a method of analyzing a genome sequence is applied, according to an exemplary embodiment of the present inventive concept.

### DETAILED DESCRIPTION OF THE EMBODIMENTS

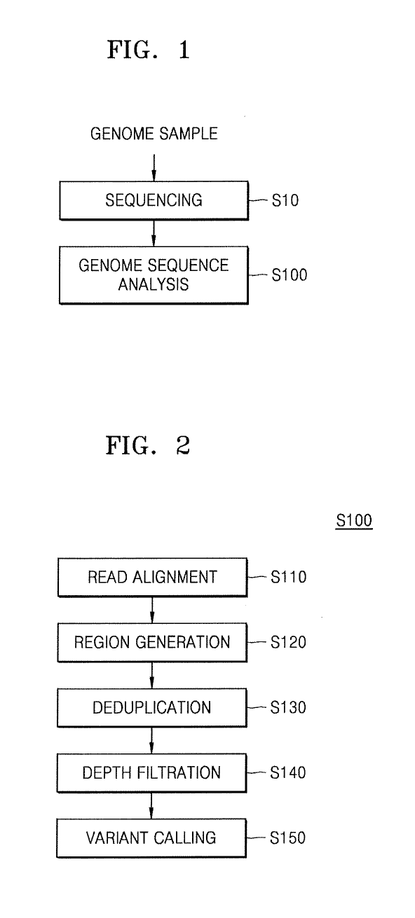

FIG. 1 is a flowchart illustrating an operating method of an apparatus for analyzing a genome sequence according to an exemplary embodiment of the present inventive concept.

Referring to FIG. 1, an operating method of an apparatus for analyzing a genome sequence may include genome sample sequencing S10 and genome sequence analysis S100.

In sequencing S10, genome information may be acquired from a genome sample extracted from an individual, for example, blood, saliva, or other bodily tissues. A plurality of read sequences regarding the acquired genome information may be generated. The read sequence refers to a partial piece of a base sequence of the genome sample to be analysed using genome sequence analysis. The read sequences generated by sequencing S10 may include a sequence of nucleotides or base pairs (bp) having an arbitrary length. AS an example, the read sequences may be from about 10 to about 2000 bp, about 15 to about 1500 bp, about 20 to about 1000 bp, about 20 to about 500 bp, or about 20 to about 200 bp. Several thousands or millions of read sequences may be generated by performing sequencing S10.

Sequencing S10 is general gene sequencing known in the art and refers to an operation in which genome information such as a deoxyribonucleic acid (DNA) base sequence, may be acquired from the genome sample.

A genome is an aggregate of genetic materials from a particular organism. Each human cell includes 23 pairs of chromosomes (46 chromosomes, for a man, 22 pairs+XY, for a woman, 22 pairs+XX). A genome may refer to a set of genetic materials transmitted from a parent to a descendant. An example in which the genome includes DNA will be described in more detail below; however, exemplary embodiments of the present invention are not limited thereto.

In genome sequence analysis S100, the sequence of the genome is analyzed using the read sequences acquired by performing sequencing S10. In an exemplary embodiment of the present inventive concept, by performing genome sequence analysis S100, a variant of a wild type genetic sequence, such as a single nucleotide variant (SNV) or a copy number variant (CNV) may be analyzed. However, exemplary embodiments of the present invention are not limited thereto.

The term “SNV” refers to substitution of single nucleotide compared with a wild type genetic sequence. CNV refers to a gene that repetitively occurs due to loss or amplification of a larger region (e.g., a repeating gene sequence that appears as a different number of repeats than a number of repeats in a wild type genetic sequence).

In genome sequence analysis S100 according to an exemplary embodiment of the present inventive concept, a reference genome may be divided into a plurality of regions based on information regarding read sequences mapped to a reference genome. An object of which a genome sequence is to be analyzed, may be set based on depth information regarding the mapped read sequences. Depth may refer to redundancy of coverage. For example, in next-generation sequencing, coverage may refer to average raw or aligned read depth, which may refer to the expected coverage on the basis of the number and the length of high-quality reads based on alignment with a reference sequence.

Genome sequence analysis S100 will be described in more detail below with reference to FIG. 2.

FIG. 2 is a flowchart illustrating genome sequence analysis an exemplary embodiment of the present inventive concept

FIG. 2 is a flowchart of genome sequence analysis S100 of FIG. 1.

Referring to FIG. 2, genome sequence analysis S100 may include read alignment S110, region generation S120, deduplication S130, depth filtration S140, and variant calling S150.

In read alignment S110, the read sequences acquired by performing sequencing S10 may be mapped to the reference genome. In region generation S120, the reference genome to which the read sequences are mapped, may be divided into a plurality of first regions. In deduplication S130, duplicated read sequences among the read sequences mapped to the reference genome may be removed. In depth filtration S140, an arbitrary interval may be removed from an object to be analyzed, using depth information regarding the read sequences mapped to the reference genome. In variant calling S150, a variant may be identified by comparison with the reference genome and analyzing the read sequences mapped to the reference genome.

In read alignment S110, a relatively large amount of read sequences acquired in sequencing (see S10 of FIG. 1) may be mapped to the reference genome. The reference genome may refer to a sequence in which nucleic acid information such as a base sequence are already known, such as through a genome project regarding the genome. Information regarding the reference genome may be acquired from a database (DB) already known in the art, such as National Center for Biotechnology Information (NCBI), Gene Expression Omnibus (GEO), Food and Drug Administration (FDA), My Cancer Genome, or Korea Food and Drug Administration (KFDA). As an example, the reference genome may be acquired from public genome data or public HAPMAP data.

Methods of read alignment S110 may include a seed & extend method, or a method using a partial combination sequence.

The seed & extend method is a method in which read sequences generated from a genome sample are mapped to a certain position of a reference genome of which nucleic acid information regarding an individual is already known. As an example, in the seed & extend method, the read sequences are compared with the reference genome and are mapped to the reference genome, and all the read sequences are not compared with the reference genome from the first time but a partial sequence or seed of the read sequences is extracted and the extracted partial sequence is compared with the reference genome.

The partial combination sequence in the method using the partial combination sequence refers to a sequence in which two or more adjacent partial seeds are combined with each other. The partial combination sequence may be a combination of at least two or more adjacent partial seeds among partial seeds. The adjacent partial seeds may include two or more partial seeds that overlap each other or are connected, two or more partial seeds of which a predetermined number overlap each other or are connected, or two or more partial seeds connected to each other while a predetermined number of partial seeds is lost.

In the case of the seed & extend method and the method using the partial combination sequence, each of the read sequences may be independently mapped to each of the reference genomes of a particular chromosome. Thus, mapping operations between the read sequences may be independent operations without interaction. As an example, the mapping operation of each of the read sequences means that distributed processing may be performed using several nodes.

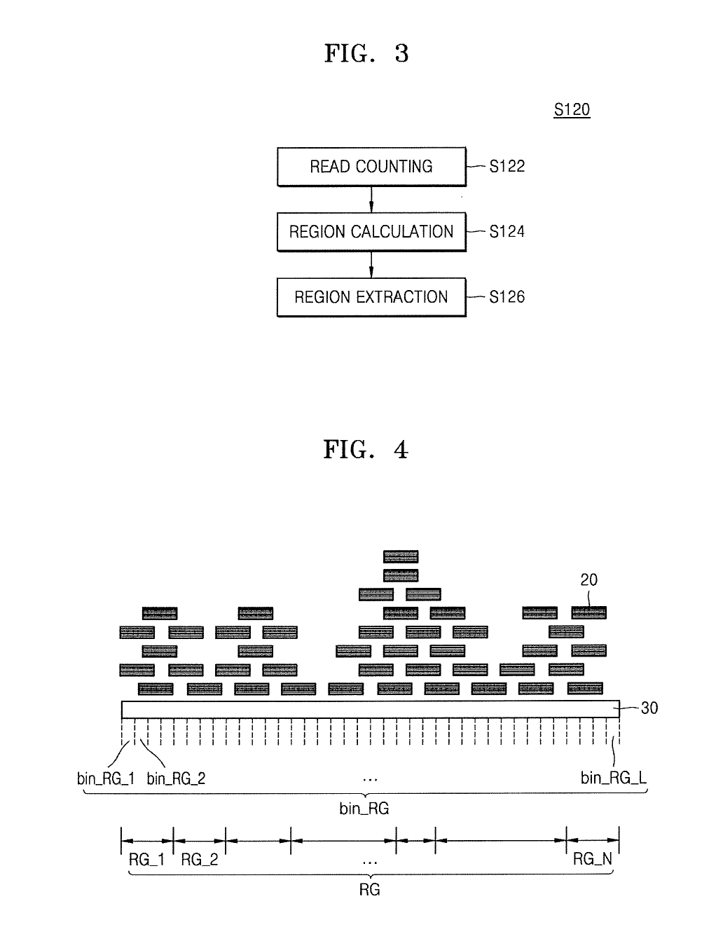

In region generation S120, the reference genome may be divided into a plurality of first regions for analysis through distributed processing. In an exemplary embodiment of the present inventive concept, the reference genome may be divided into a plurality of first regions based on information regarding the number of mapped read sequences. Region generation S120 will be described in more detail below with reference to FIGS. 3 and 4.

After the reference genome is divided into the plurality of first regions, duplicated read sequences may be removed by performing deduplication S130. The duplicated read sequences may be generated during amplification caused by a polymerase chain reaction (PCR) in sequencing. The duplicated read sequences may be removed by performing distributed processing on each of the first regions. By reducing the number of extraneous read sequences in deduplication S130, a proceeding speed of subsequent operations may be increased.

In an exemplary embodiment of the present inventive concept, deduplication S130 may be omitted. In this case, depth filtration S140 may be performed after region generation S120 is performed.

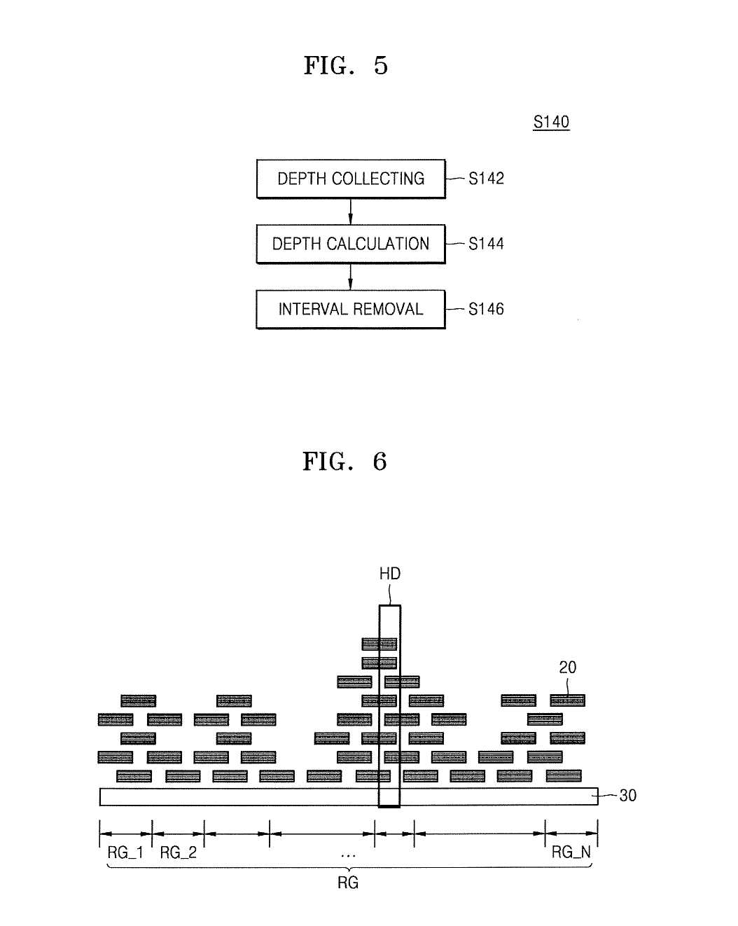

In depth filtration S140, depth information regarding the read sequences may be checked so that an arbitrary interval may be removed from the object of which a genome sequence is to be analyzed. In an exemplary embodiment of the present inventive concept, the depth information regarding the read sequences may be frequency information regarding depth. Depth filtration S140 will be described in more detail below with reference to FIGS. 5 and 6.

A variant of the genome may be checked in variant calling S150. In an exemplary embodiment of the present inventive concept, variant calling S150 may be performed by performing distributed processing on the first regions divided in region generation S120. After distributed processing is performed, information regarding a variant of the genome checked from each of the first regions may be integrated. In an exemplary embodiment of the present inventive concept, after depth filtration S140 is performed, local realignment and/or base recalibration is further performed and then, variant calling S150 may be performed.

FIG. 3 is a flowchart illustrating region generation of FIG. 2 according to an exemplary embodiment of the present inventive concept. FIG. 4 illustrates a reference genome divided into a plurality of first regions, an exemplary embodiment of the present inventive concept.

FIG. 3 illustrates a process of region generation S120 of FIG. 2. FIG. 4 is a view of a state in which a reference genome 30 is divided into a plurality of first regions RG by performing region generation S120 according to an exemplary embodiment of the present inventive concept.

Referring to FIG. 3, region generation S120 may include read counting S122, region calculation S124, and region extraction S126.

In read counting S122, the reference genome 30 may be divided into a plurality of second regions bin_RG, and information regarding the number of read sequences 20 may be included in each of the plurality of second regions bin_RG. In region calculation S124, the information regarding the number of read sequences 20 included in the second regions bin_RG may be integrated, and the average number of read sequences 20 may be calculated from the information regarding the number of read sequences 20 and information regarding the targeted number of first regions RG. In region extraction S126, the first regions RG may be extracted from the average number of read sequences 20.

Referring to FIGS. 3 and 4, in read counting S122, the reference genome 30 may be divided into the plurality of second regions bin_RG. The plurality of second regions bin_RG may be arbitrary regions to be divided into a plurality of first regions RG. Each of the plurality of second regions bin_RG may have substantially a same length as each other; however, exemplary embodiments of the present invention are not limited thereto. Referring to FIG. 4, the first regions RG may include RG_1 to RG_N, and the second regions bin_RG may include bin_RG_1 to bin_RG_L. In an exemplary embodiment of the present inventive concept, N and L are natural numbers, in which L is an integer greater than or equal to N.

In read counting S122, the reference genome 30 may be divided into the plurality of second regions bin_RG, and the number of read sequences 20 included in each of the second regions bin_RG may be checked. The number of read sequences 20 may be checked using position information regarding the read sequences 20 mapped to the reference genome 30. The position information may be position information in chromosomes, for example. In an exemplary embodiment of the present inventive concept, checking of the number of read sequences 20 included in each of the second regions bin_RG may be performed by performing distributed processing on each of the second regions bin_RG.

In read counting S122, the number of read sequences 20 included in each of the second regions bin_RG is checked, and the number of all the read sequences 20 mapped to the reference genome 30 may be calculated by integrating the information regarding the number of read sequences 20 included in each of the second regions bin_RG. After the number of all the read sequences 20 mapped to the reference genome 30 is calculated, the calculated number of read sequences 20 may be divided by the targeted number of first regions RG, thus calculating an average value. Referring to FIG. 4, the reference genome 30 may be divided into seven first regions RG. However, exemplary embodiments of the present invention are not limited thereto, and the number of first regions RG may be set, as desired. For example, the number of first regions RG may be set in consideration of a distributed processing capability.

If information regarding the average number of read sequences 20 suitable for the targeted number of first regions RG is checked in region calculation S124, in region extraction S126, the first regions RG may be extracted using the second regions bin_RG and the information regarding the average number of read sequences 20. Each of the first regions RG may be extracted by sequentially merging the plurality of second regions bin_RG. In an exemplary embodiment of the present inventive concept, the plurality of second regions bin_RG may be integrated until the number of read sequences 20 mapped to each of the first regions RG reaches the average number based on information regarding the average number of read sequences 20 suitable for the targeted number of first regions RG. In an exemplary embodiment of the present inventive concept, the reference genome 30 may be divided into the plurality of first regions RG by integrating the second regions bin_RG, and information regarding the mapped read sequences 20 according to the first regions RG may be generated as a file. The file may be generated by performing distributed processing on the first regions RG.

According to an exemplary embodiment of the present inventive concept, the reference genome 30 may be divided into the plurality of first regions RG based on the number of mapped read sequences 20 so that the read sequences 20 having a substantially uniform number may be placed in each of the first regions RG. According to an exemplary embodiment of the present inventive concept, the read sequences 20 may be analyzed in a distributed processing environment based on the first regions RG to achieve increased consistency in a processing time for each of the first regions RG. Thus, the total genome data analysis time may be reduced. Also, a duty cycle of a resource of the distributed processing system may be reduced.

FIG. 5 is a flowchart illustrating a process of depth filtration an exemplary embodiment of the present inventive concept. FIG. 6 illustrates a high depth interval (HD) divided from a reference genome according to an exemplary embodiment of the present inventive concept.

FIG. 5 is a detailed flowchart illustrating a process of filtration S140. FIG. 6 is a view of a state in which a high depth interval (HD) is divided from the reference genome 30 by performing depth filtration 140 according to an exemplary embodiment of the present inventive concept.

Referring to FIG. 5, depth filtration S140 may include depth collecting S142, depth calculation S144, and interval removal S146.

In depth collecting S142, depth information regarding the mapped read sequences 20 in each of the first regions RG of the reference genome 30 may be checked. In depth calculation S144, depth information regarding the mapped reference sequences 20 in each of the first regions RG of the reference genome 30 may be integrated, and a plurality of statistical values may be calculated based on the integrated depth information. In interval removal S146, an interval to be removed from an object to be analyzed may be set using the calculated statistical values.

Referring to FIGS. 5 and 6, in depth collecting S142, information regarding a depth of each of the read sequences 20 in each of the first regions RG of the reference genome 30 may be checked. The depth of the read sequences 20 change based on a position of the reference genome 30. The term “position” may refer to distance from an arbitrary base to another arbitrary base and may include a plurality of bases. In an exemplary embodiment of the present inventive concept, the information regarding the depth may be frequency information. Depth collecting S142 may be performed by performing distributed processing on each of the first regions RG.

In depth collecting S142, the depth information regarding the read sequences 20 in each of the first regions RG may be checked. In depth calculation S144, pieces of information (e.g., a depth or frequency of occurrence of each read sequence 20) may be integrated, and statistical values (e.g., average depth, maximum depth and/or minimum depth) may be calculated based on the pieces of information. In an exemplary embodiment of the present inventive concept, the depth information may be frequency information, and the statistical values calculated based on the frequency information may include modes, averages and/or standard deviations. The mode may be the greatest frequency or depth of a particular read sequence 20.

In depth calculation 144, statistical values may be calculated for the read sequences 20. In interval removal S146, a reference value may be calculated based on the statistical values. In an exemplary embodiment of the present inventive concept, when the statistical values calculated in depth calculation S144 include modes and/or standard deviations, the reference value may have a value of [2×mode+3×standard deviation]. However, the reference value is not limited thereto.

In the case of normal (e.g., wild type) DNA, after read alignment (e.g., S110) is performed, the read sequences 20 may be mapped to the reference genome 30 to a relatively uniform depth. However, when a structure variant occurs in a DNA sequence, the DNA sequence may be moved to another position, and due to the moved DNA the depth of the mapped read sequences 20 may be twice or more the depth of the mapped read sequences 20 in a normal state position. In an exemplary embodiment of the present inventive concept, the formula [2×mode+3×standard deviation] may include ‘2×mode’ in consideration of the structure variant, and ‘3×standard deviation’ which represents 99.9% of a standard distribution.

Referring to FIG. 6, the read sequences 20 may be mapped to the reference genome 30, and the reference genome 30 may be divided into a plurality of first regions RG. In an exemplary embodiment of the present inventive concept, the first regions RG may be divided based on the information regarding the number of mapped read sequences 20.

The HD that exceeds the reference value calculated in depth calculation S144 may be distinguished from other first regions RG. In an exemplary embodiment of the present inventive concept, the HD may have a depth that exceeds the reference value according to the formula [2×mode+3×standard deviation] and may be removed from the genome sequence analysis, by performing interval removal S146.

Referring to FIG. 6, one HD is distinguished from other first regions RG. However, exemplary embodiments of the present invention are not limited thereto, and a plurality of HDs may be distinguished by the reference value.

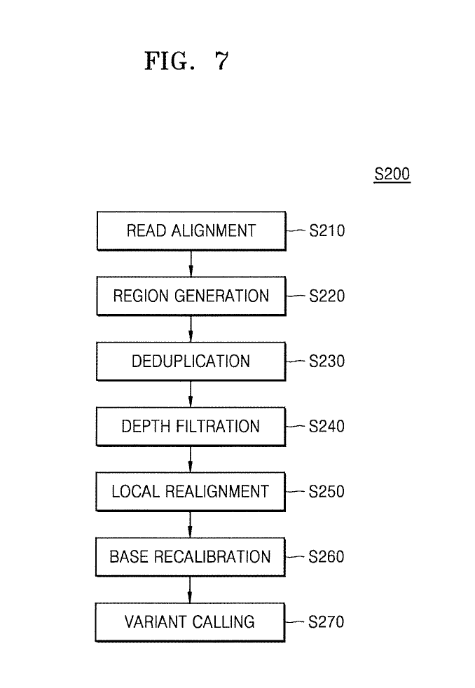

FIG. 7 is a flowchart illustrating genome sequence analysis according to an exemplary embodiment of the present inventive concept.

FIG. 7 is a flowchart illustrating a process of genome sequence analysis S200 according to an exemplary embodiment of the present inventive concept. Referring to FIG. 7, descriptions of operations described above may be omitted, and thus duplicative descriptions may be omitted.

Referring to FIG. 7, genome sequence analysis S200 may include read alignment S210, region generation S220, deduplication S230, depth filtration S240, local realignment S250, base recalibration S260, and variant calling S270. In local realignment S250, an unmapped portion in read alignment S210 may be mapped again. In base recalibration S260, a base score may be recalibrated through an empirical model configuration.

Duplicated read sequences among the mapped read sequences may be removed in deduplication S230. In local realignment S250, an unmapped portion may be mapped again. In an exemplary embodiment of the present inventive concept, in read alignment S210, mapping need not be performed at a distal end of DNA, and in local realignment S250, the distal end of DNA, at which mapping is not performed, may be mapped again. However, exemplary embodiments of the present invention are not limited thereto.

After mapping of the read sequences in local realignment S250, base recalibration S260 may be performed. Variant calling may depend on a base score of each of the read sequences. The base score may refer to an error score estimated in a sequencing machine per base. Since the error in the sequencing machine may occur due to technical factors, the estimation need not be exact. Thus, in base recalibration S260, an empirical model of error rates may be performed, and the base score may be applied to the empirical model and recalibrated. Generating the empirical model may include generating a table including error rates per base.

In an exemplary embodiment of the present inventive concept, local realignment S250 and/or base recalibration S260 may be performed through a genome analysis toolkit (GATK). However, exemplary embodiments of the present invention are not limited thereto.

The operating method of the apparatus for analyzing the genome sequence according to an exemplary embodiment of the present inventive concept described with reference to FIGS. 1 through 7 may be implemented by program instructions that may be executed by various computer units and may be recorded on a computer-readable recording medium. The computer-readable recording medium may solely include program instructions, data files, and a data structure, or a combination thereof. The program instructions recorded on the computer-readable recording medium may be specifically designed and configured for this disclosure or publicly known to those skilled in the art of computer software and available. Examples of the computer-readable recording medium include magnetic media such as a hard disk, a floppy disk, and a magnetic tape, optical media such as CD-ROMs or DVDs, magneto-optical media such as floptical disk, and a hardware device specially configured to store and execute program instructions, such as read-only memory (ROM), random-access memory (RAM), and flash memory. Examples of the program instructions include machine language codes made by a compiler and high-level language codes that may be executed by a computer using an interpreter, etc.

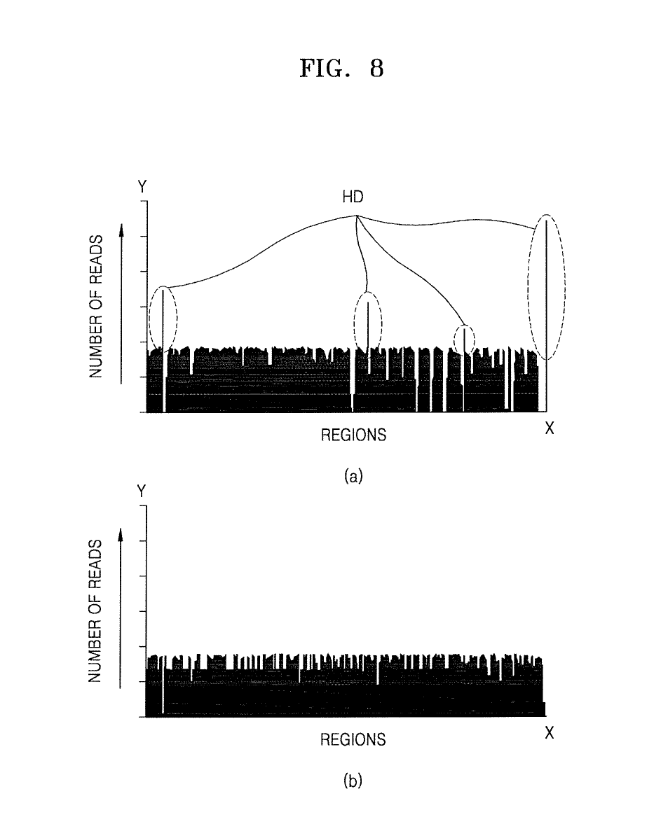

FIG. 8 is a distribution chart in a case where region generation and depth filtration according to an exemplary embodiment of the present inventive concept are not applied, and a distribution chart in a case where region generation and depth filtration according to an exemplary embodiment of the present inventive concept are applied.

FIG. 8 includes a distribution chart (a) and a distribution chart (b) illustrating a case where region generation (e.g. S120) and depth filtration (e.g., S140) according to an exemplary embodiment of the present inventive concept are not applied, and a case where region generation (e.g., S120) and depth filtration (e.g., S140) according to an exemplary embodiment of the present inventive concept are applied, respectively. Distribution chart (a) and distribution chart (b) represent the number of read sequences mapped to divided regions of a reference genome. The y-axis in each distribution chart represents the number of reads, and the x-axis represents divided regions of the reference genome. On the y-axis, the number of reads may be increased along an arrow direction. The divided regions of distribution chart (b) may be first regions (e.g., RG) according to an exemplary embodiment of the present inventive concept. In an exemplary embodiment of the present inventive concept, distribution chart (a) may be a case where the reference genome is divided into a plurality of regions having the same length.

Comparing (a) with (b), in the case of distribution chart (a), HDs of the read sequences compared to other regions exist. The distribution of read sequences mapped to each of the regions is not uniform in distribution chart (a). In distribution chart (b) according to an exemplary embodiment of the present inventive concept, the HDs of distribution chart (a) are eliminated, and the distribution of the read sequences mapped to each of the regions is more uniform compared to distribution chart (a).

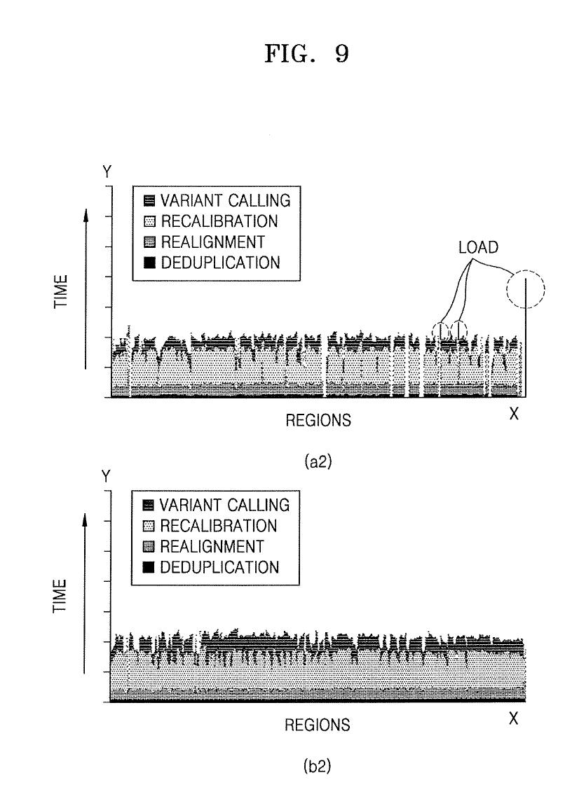

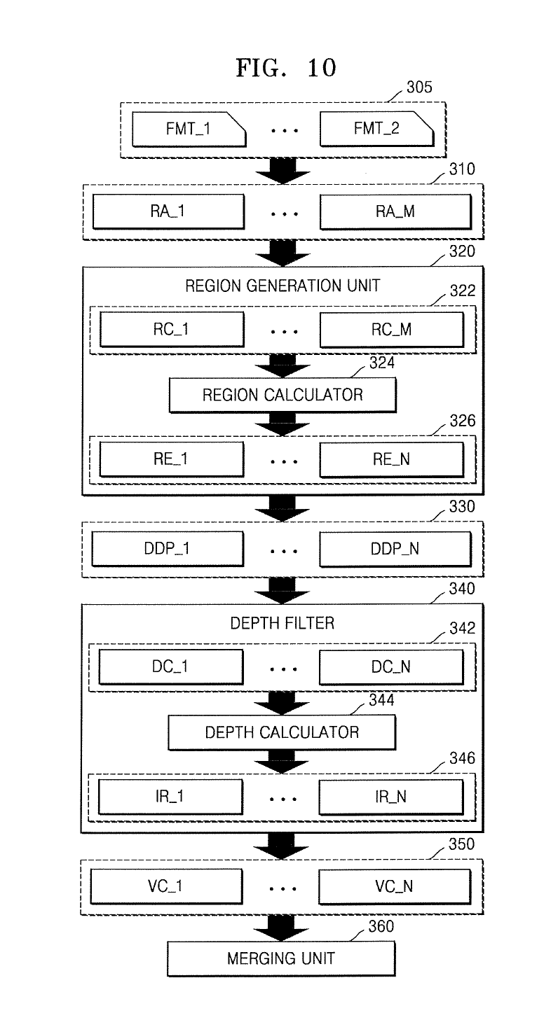

FIG. 9 is a distribution chart illustrating a proceeding time according to regions of subsequent analysis operations in each of the cases of FIG. 8 according to an exemplary embodiment of the present inventive concept.

FIG. 9 is a distribution chart illustrating a proceeding time of divided regions of a reference genome. The reference genome may be divided into a plurality of regions and then the regions may each be processed and subsequent analysis operations may be performed in each of the cases of FIG. 8. The subsequent analysis operations may be deduplication, local realignment, base recalibration and/or variant calling. Distribution chart (a2) may be a distribution chart in which the subsequent analysis operations are performed in the case of distribution chart (a) of FIG. 8, and distribution chart (b2) may be a distribution chart in which the subsequent analysis operations are performed in the case of distribution chart (b) of FIG. 8. The y-axis of each distribution chart represents time, and the x-axis represents divided regions of the reference genome. On the y-axis, time may be increased along an arrow direction. The divided regions of distribution chart (b2) may be first regions (e.g., RG) according to an exemplary embodiment of the present inventive concept. In an exemplary embodiment of the present inventive concept, distribution chart (a2) may be a case where the reference genome is simply divided into a plurality of regions having the same length.

Comparing (a2) with (b2), in the case of distribution chart (a2), regions LOAD, in which analysis is performed for a longer time than other regions, exist. Also, the distribution of time required for analysis in each of the regions is not uniform. In the case of distribution chart (b2), in which region generation (e.g., S120) and/or depth filtration (e.g., S140) are applied an exemplary embodiment of the present inventive concept, the regions LOAD, in which analysis is performed for a longer time, illustrated in distribution chart (a2), are reduced, and the distribution of time required for analysis in each of the regions is more uniform compared to distribution chart (a2).

FIG. 10 is a view of a distributed processing system for analyzing a genome sequence according to an exemplary embodiment of the present inventive concept.

FIG. 10 is a view of a configuration of a distributed processing system 300 for analyzing a genome sequence according to an exemplary embodiment of the present inventive concept. Referring to FIG. 10, the distributed processing system 300 for analyzing the genome sequence according to an exemplary embodiment of the present inventive concept may include a formatting unit 305, a read alignment unit 310, a region generation unit 320, a deduplication unit 330, a depth filtration unit 340, a variant calling unit 350, and a merging unit 360. The distributed processing system 300 for analyzing the genome sequence according to an exemplary embodiment of the present inventive concept may perform operations to be time-sequentially performed by the method S100 described in more detail with reference to FIG. 2. Duplicative descriptions of method S100 to those described above may be omitted. Thus, the above descriptions of the method S100 of analyzing the genome sequence may also be applied to the distributed processing system 300 for analyzing the genome sequence according to an exemplary embodiment of the present inventive concept.

The formatting unit 305 may include a plurality of formats FMT_1 to FMT_M. Pieces of information regarding the read sequences generated by sequencing and/or information regarding a base score may be stored in each of the formats FMT_1 to FMT_M. In an exemplary embodiment of the present inventive concept, the pieces of information may be encoded in a single ASCII code. The formats FMT_1 to FMT_M may be FASTQ or FASTA formats. However, exemplary embodiments of the present invention are not limited thereto. Referring to FIG. 10, the plurality of formats FMT_1 to FMT_M may be expressed as M. M may be a natural number that is equal or greater than 2.

The read alignment unit 310 may receive the sequenced information regarding the read sequences from the formatting unit 305 and may map the read sequences of the plurality of formats FMT_1 to FMT_M to a reference genome. In an exemplary embodiment of the present inventive concept, the read alignment unit 310 may include unit read alignments RA_1 to RA_M having the same number as that of the plurality of formats FMT_1˜FMT_M included in the formatting unit 305. The unit read alignments RA_1 to RA_M included in the read alignment unit 310 may perform a distributed process.

The region generation unit 320 may divide the reference genome to which mapping of the read sequences is completed by the read alignment unit 310, into a plurality of regions.

In an exemplary embodiment of the present inventive concept, the region generation unit 320 may include a read counter 322, a region calculator 324, and a region extractor 326.

The read counter 322 may divide the reference genome into a plurality of second regions and may calculate information regarding the number of read sequences included in each of the second regions. In an exemplary embodiment of the present inventive concept, the read counter 322 may include unit read counters RC_1 to RC_M having the same number as that of the unit read alignments RA_1 to RA_M. Each of the unit read counters RC_1 to RC_M included in the read counter 322 may perform a distributed process.

The region calculator 324 may calculate a total number of read sequences by synthesizing the number of read sequences calculated by each of the unit read counters RC_1 to RC_M and may calculate the average number of read sequences by dividing the number of all the read sequences by a targeted number of first regions.

The region extractor 326 may extract the first regions so that the number of mapped read sequences in each of the first regions based on the average number of read sequences reaches the average number of read sequences. In an exemplary embodiment of the present inventive concept, the region extractor 326 may include unit region extractors RE_1 to RE_N having the same number as a targeted number of first regions. The region extractor 326 may generate information regarding the extracted first region, may perform distributed processing on the unit region extractors RE_1˜RE_N and may generate a file including information regarding the first regions. Regarding FIG. 10, a targeted number of first regions may be expressed as N. N may be a natural number that is equal to or greater than 2.

The deduplication unit 330 may remove duplicated read sequences by performing distributed processing on at least some of the N first regions. In an exemplary embodiment of the present inventive concept, the deduplication unit 330 may perform deduplication using SAMtools, SAMBLASTER and/or PICARD tools. However, exemplary embodiments of the present invention are not limited thereto.

The depth filtration unit 340 may remove a HD from an object to be analyzed, using the depth information regarding the read sequences.

In an exemplary embodiment of the present inventive concept, the depth filtration unit 340 may include a depth collector 342, a depth calculator 344, and an interval removal unit 346.

The depth collector 342 may calculate information regarding the depth of the read sequences mapped to the reference genome by performing distributed processing on the N first regions. In an exemplary embodiment of the present inventive concept, the depth collector 345 may include N unit depth collectors DC_1 to DC_N having the same number as that of the first regions. Each of the unit depth collectors DC_1 to DC_N included in the depth collector 342 may perform a distributed process.

The depth calculator 344 may merge the information regarding the depth of the read sequences calculated from the unit depth collectors DC_1 to DC_N and may calculate statistical values based on the merged information. In an exemplary embodiment of the present inventive concept, the information regarding the depth may be frequency information, and the statistical values calculated based on the information regarding the depth may be modes, average values and/or standard deviations.

The interval removal unit 346 may perform distributed processing on the N first regions using the statistical values and may set an interval removed from the object to be analyzed. Setting of the interval to be removed may be performed using reference values calculated based on the statistical values calculated by the depth calculator 344. The interval removal unit 346 may include N unit removal units IR_1 to IR_N having the same number as that of the first regions.

The variant calling unit 350 may identify a variant by performing distributed processing on the N first regions. In an exemplary embodiment of the present inventive concept, the variant calling unit 350 may include N unit calling units VC_1 to VC_N having the same number as that of the first regions. In an exemplary embodiment of the present inventive concept, an output of the depth filtration unit 340 may be an input of a local realignment unit and/or a base recalibration unit so that an output of the local realignment unit and/or the base recalibration unit may be an input of the variant calling unit 350.

The merging unit 360 may merge information generated by the distributed processed described above and called by the variant calling unit 350. In an exemplary embodiment of the present inventive concept, the information generated by the distributed processes described above and/or the merged information may be output in the form of a file.

In an exemplary embodiment of the present inventive concept, the distributed processing system 300 for analyzing the genome sequence described with reference to FIG. 10 may perform genome sequence analysis in a pipeline manner. Thus, according to an exemplary embodiment of the present inventive concept, the reference genome may be divided into a plurality of first regions based on information regarding the number of mapped read sequences, and the read sequences may be analyzed by performing distributed processing on the first regions so that similarity of a processing time according to regions is increased and a performance time for the entire genome data analysis may be reduced. Also, a duty cycle of a resource of the distributed processing system may be reduced.

The distributed processing system 300 for analyzing the genome sequence may include hardware (e.g., or hardware components) for performing genome sequence analysis, software (e.g., or software components) for performing genome sequence analysis, and/or an electronic recording medium having a computer program code for performing genome sequence analysis recorded thereon. However, exemplary embodiments of the present invention are not limited thereto, and the distributed processing system 300 for analyzing the genome sequence may include a functional and/or structural combination of hardware or software for driving the hardware.

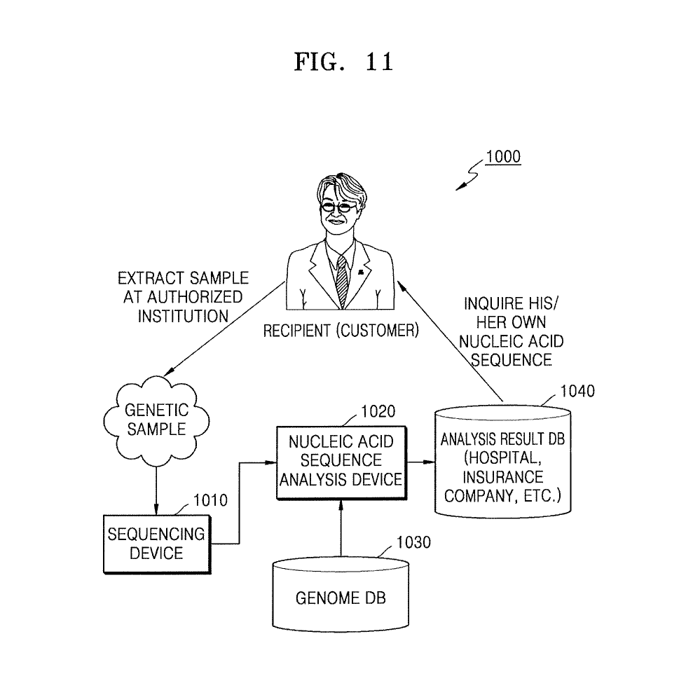

FIG. 11 illustrates a system for analyzing a genome sequence to which a method of analyzing a genome sequence is applied, according to an exemplary embodiment of the present inventive concept.

FIG. 11 illustrates a system 1000 for analyzing the genome sequence to which the method of analyzing the genome sequence according to an exemplary embodiment of the present inventive concept is applied.

Referring to FIG. 11, a genetic sample of a recipient (customer) who requests genome sequencing, for example, blood, saliva, or other bodily tissues, may be extracted at an authorized institution. The genetic sample may be the recipient's (customer's) DNA sample.

The recipient's DNA is a genetic material including the recipient's genetic information. DNA may be indicated as a kind of base sequence including four kinds of bases A, G, T, and C. A DNA sequence includes information regarding cells, tissues, etc. of an individual, and bases of the DNA sequence represent information regarding a connection order or an arrangement order of 20 kinds of amino acids that are protein query constituents of the individual. A particular genetic characteristic represented by the sequence of DNA that is a gene is determined according to information regarding bases in the DNA sequence.

For example, the individual's DNA sequence information includes information related to past and future diseases. Thus, if DNA sequence information regarding a person having a disease and DNA sequence information regarding a person having no disease can be accurately compared with each other and checked, the disease might be prevented, or an optimum treatment method at an initial stage of the disease can be selected.

A sequencing device 1010 may generate read sequences from the extracted genetic sample. A nucleic acid sequence analysis device 1020 may perform genome sequence analysis according to an exemplary embodiment of the present inventive concept. Thus, the nucleic acid sequence analysis device 1020 may divide a reference genome into a plurality of first regions based on information regarding the read sequences mapped to the reference genome. The nucleic acid sequence analysis device 1020 may perform distributed processing on the plurality of first regions and may then merge results of analysis processing of each of the first regions and analyzes them so that the result of analysis in which nucleic acid information regarding the recipient's genetic sample is compared with a reference genome (e.g., obtained from a genome database 10230). An analysis result database (DB) 1040 may store the result of analysis.

While the present inventive concept has been particularly shown and described with reference to exemplary embodiments thereof, it will be understood that various changes in form and details may be made therein without departing from the spirit and scope of the present inventive concept.

What is claimed is:

1. An operating method of an apparatus for analyzing a genome sequence, the operating method comprising:
mapping a plurality of sequenced read sequences to a reference genome;
calculating a number of mapped read sequences;
dividing the reference genome into a plurality of first regions based on the number of mapped read sequences; and
analyzing the mapped read sequences in each of the plurality of first regions by performing distributed processing on the plurality of first regions.

2. The operating method of claim 1, wherein the calculating of the number of mapped read sequences comprises:
dividing the reference genome into a plurality of second regions;
calculating the number of read sequences mapped to each of the plurality of second regions; and
adding the number of read sequences mapped to each of the second regions.

3. The operating method of claim 2, wherein the number of second regions is greater than or equal to the number of first regions.

4. The operating method of claim 2, wherein the calculating of the number of read sequences mapped to each of the plurality of second regions is performed by performing distributed processing on each of the second regions.

5. The operating method of claim 2, wherein the dividing of the reference genome into a plurality of first regions based on the number of mapped read sequences comprises:
calculating a first reference value using a total number of read sequences; and
extracting the first regions by sequentially merging the second regions based on the first reference value and the number of read sequences mapped to each of the second regions.

6. The operating method of claim 5, further comprising setting a targeted number of the first regions, wherein the first reference value is a value obtained by dividing the calculated number of all the read sequences by the targeted number of the first regions.

7. The operating method of claim 5, wherein the extracting of the first regions comprises merging the second regions until the number of read sequences mapped to the merged second regions reaches the first reference value.

8. The operating method of claim 2, further comprising:
extracting frequency information regarding a depth of the read sequences with respect to each of the first regions; and
setting an analysis object interval in each of at least some of the first regions using the frequency information.

9. The operating method of claim 8, further comprising removing duplicated read sequences from the at least some of the first regions.

10. An operating method of an apparatus for analyzing a genome sequence, the operating method comprising:
receiving a plurality of read sequences of a genome;
mapping the plurality of received read sequences to a reference genome;
dividing the reference genome into a plurality of regions;
extracting frequency information regarding a depth of the mapped read sequences;
setting a maximum depth based on the frequency information; and
analyzing the read sequences mapped to each of the regions by performing distributed processing on the read sequences below the maximum depth.

11. The operating method of claim 10, wherein setting the maximum depth includes:
calculating a statistical value using the extracted frequency information; and
calculating a reference value using the calculated statistical value.

12. The operating method of claim 11, wherein the statistical value comprises at least one of a mode, an average value, or a standard deviation.

13. The operating method of claim 12, wherein the reference value has a value of [2×mode+3×standard deviation].

14. The operating method of claim 10, wherein the regions are divided based on information regarding a total number of mapped read sequences.

15. The operating method of claim 10, wherein the extracting of the frequency information is performed by performing distributed process on the plurality of regions.

16. A method of analyzing a genome, comprising:
receiving a sample including DNA;
identifying a plurality of read sequences from DNA included in the sample;
mapping the plurality of read sequences to a reference genome;
dividing the reference genome into a plurality of regions;
determining a frequency of mapping the read sequences into each of the regions of the plurality of regions of the reference genome;
setting a threshold frequency based on the frequency of mapping the read sequences into each of the regions of the plurality of regions of the reference genome; and
analyzing the read sequences below the threshold frequency.

17. The method of analyzing a genome of claim 16, wherein analyzing the read sequences below the threshold frequency is performed by distributed processing.

18. The method of analyzing a genome of claim 16, further comprising identifying a genetic variant that varies from the reference genome.

19. The method of analyzing a genome of claim 18, wherein the genetic variant comprises a single nucleotide variant (SNV) or a copy number variant (CNV).

20. The method of analyzing a genome of claim 18, wherein the genetic variant is a disease causing variant.
